(19) United States
(12) Patent Application Publication
(10) Pub. No.: US 2026/0281720 A1
(43) Pub. Date: Sep. 17, 2026

(54) VIRTUAL PRIVATE NETWORK ESTABLISHMENT INTEGRATED WITH WIFI AUTHENTICATION

(71) Applicant: Charter Communications Operating, LLC, St. Louis, MO (US)

(72) Inventor: Sagar Indrajitbhai Panchal, Denver, CO (US)

(73) Assignee: Charter Communications Operating, LLC, St. Louis, MO (US)

(21) Appl. No.: 19/078,453

(22) Filed: Mar. 13, 2025

(51) Int. Cl. H04W 12/06; H04W 12/088

(52) U.S. Cl. CPC H04W 12/06; H04W 12/088

(57) ABSTRACT

Systems and methods which enable an integrated establishment of a virtual private network (VPN) with a local wireless network authentication process. A method includes receiving, by an access point from a requesting device, an authentication request to connect to an access point, verifying, by an authentication server, authentication credentials received in the authentication request, using, by the authentication server, access point metadata and a VPN database to determine which VPN to use and a connection status of the VPN upon successful verification of the authentication credentials and when a VPN connection requirement is positive, obtaining, by the authentication server, VPN credentials for the VPN when the connection status of the VPN is unconnected, and establishing an access point connection between the access point and the requesting device and a VPN connection between the access point and a system associated with the VPN credentials.

### TECHNICAL FIELD

This disclosure relates to communications. More specifically, communications using a virtual private network.

### BACKGROUND

As enterprise networks grow in complexity and importance, ensuring secure and reliable access to network resources becomes paramount. Local wireless networks, such as, but not limited to a Wi-Fi network, often use an enterprise-grade Authentication, Authorization, and Accounting (AAA) server for managing user authentication, typically via certificates and/or username-password combinations. The AAA server plays a role in validating the credentials of the device or user seeking access to the local wireless network. In many enterprise environments, a virtual private network (VPN) is also required for secure access to sensitive resources in the enterprise, especially when connecting over wireless networks. However, the process of VPN establishment is often disjointed from the Wi-Fi authentication process.

### SUMMARY

Disclosed is a system and method which integrates establishment of a virtual private network (VPN) with a local wireless network authentication process. In implementations, a method for providing integrated virtual private network (VPN) establishment with wireless network authentication includes receiving, by an access point from a requesting device, an authentication request to connect to an access point, verifying, by an authentication server, authentication credentials received in the authentication request, using, by the authentication server, access point metadata and a VPN database to determine which VPN to use and a connection status of the VPN upon successful verification of the authentication credentials and when a VPN connection requirement is positive, obtaining, by the authentication server, VPN credentials for the VPN when the connection status of the VPN is unconnected, and establishing an access point connection between the access point and the requesting device and a VPN connection between the access point and a system associated with the VPN credentials.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a communications architecture in accordance with the teachings described herein.

FIG. 2 is a diagram of an example of the communications network of FIG. 1 after successful authentication and virtual private network (VPN) establishment in accordance with the teachings described herein.

FIG. 3 is a flow diagram of an example flow for integrating virtual private network (VPN) establishment with a local wireless network authentication process in accordance with the teachings described herein.

FIG. 4 is a flowchart of an example method for providing integration of a virtual private network (VPN) establishment with a local wireless network authentication process in accordance with the teachings described herein.

FIG. 5 is a flowchart of another example method for providing integrated virtual private network (VPN) establishment with a local wireless network authentication process in accordance with the teachings described herein.

FIG. 6 is a flowchart of yet another example method for providing integrated virtual private network (VPN) establishment with a local wireless network authentication process in accordance with the teachings described herein.

FIG. 7 is a block diagram of an example of a device in accordance with the teachings described herein.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “of” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described teachings and/or embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed teachings and/or embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Securing enterprise Wi-Fi access involves multiple layers of authentication and network control. Traditional methods for authentication include certificates or username-password pairs validated through enterprise Authentication, Authorization, and Accounting (AAA) servers. In modern enterprise networks, however, additional layers of security are often required, including dynamic virtual private network (VPN) establishment for secure access to enterprise and/or system resources. The current Wi-Fi authentication process lacks integration with VPN status verification. A user may connect to the enterprise Wi-Fi network successfully but fail to establish the required VPN connection. This disjointed approach can lead to security vulnerabilities and access issues, especially in environments where secure VPN connectivity is mandatory.

Described herein is a system and method for integrating virtual private network (VPN) establishment with a local wireless network authentication process. In implementations, an extended authentication framework is provided which integrates access point metadata with dynamic VPN state validation. By leveraging access point information during authentication and cross-referencing a VPN status database, the extended authentication framework and/or mechanism may ensure seamless VPN establishment when necessary, enabling secure user access to enterprise and/or system resources.

In implementations, a method is provided which dynamically establishes VPN connections based on metadata received during Wi-Fi authentication.

In implementations, an authentication flow is provided which, upon receiving an authentication request, validates the credentials of the user or device, checks the access point's metadata (such as, but not limited to, a Media Access Control (MAC) address and Internet Protocol (IP) address), and consults a VPN database table to ensure the correct VPN is established, if required.

In implementations, a traditional Wi-Fi authentication process may be extended by incorporating access point metadata and checking VPN state tables. This may ensure that when a device connects to the enterprise Wi-Fi, the required VPN connection is automatically established based on the authentication data and access point information.

In implementations, systems and methods are provided which integrate access point metadata with VPN status for dynamic VPN establishment.

In implementations, systems and methods are provided which integrate access point metadata with VPN status for automatic VPN establishment.

In implementations, systems and methods provide on-the-go VPN establishment using enterprise Wi-Fi authentication with access point metadata.

By ensuring that the required VPN is established automatically as part of the authentication process, the described method and system may eliminate the risk of unsecured connections and minimize human error in VPN configurations. End users benefit from a seamless experience where VPN connections are established dynamically without manual intervention, reducing complexity for non-technical users. That is, the described method and system may provide enhanced security and simplify the user experience.

In implementations, the systems and methods extend enterprise Wi-Fi authentication process by incorporating access point metadata and dynamically establishing VPN connections based on user requirements and VPN status. By integrating VPN establishment into the authentication flow, the systems and methods ensure secure and seamless access to enterprise resources, enhancing both security and user experience.

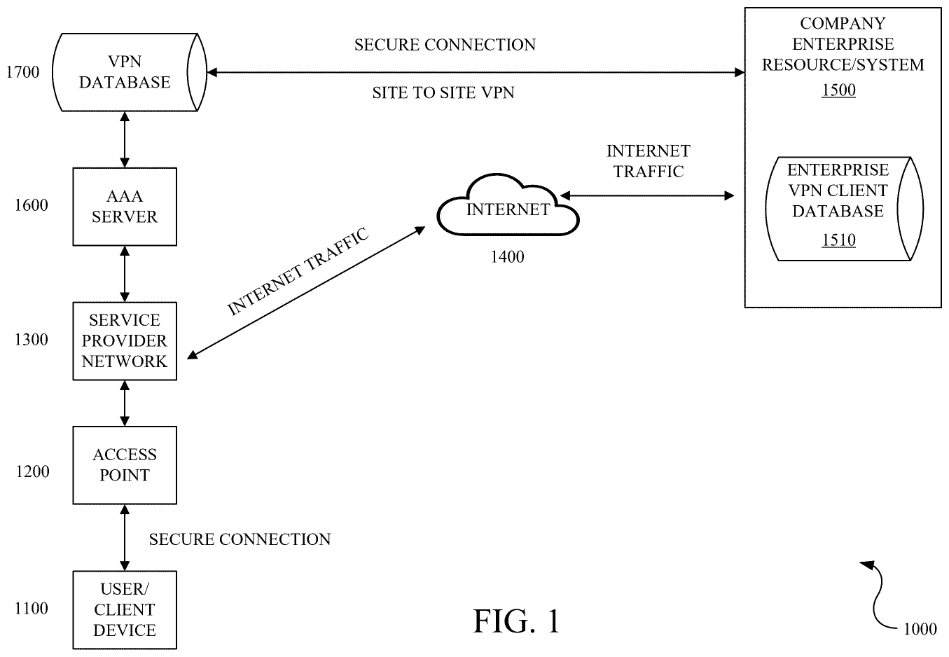

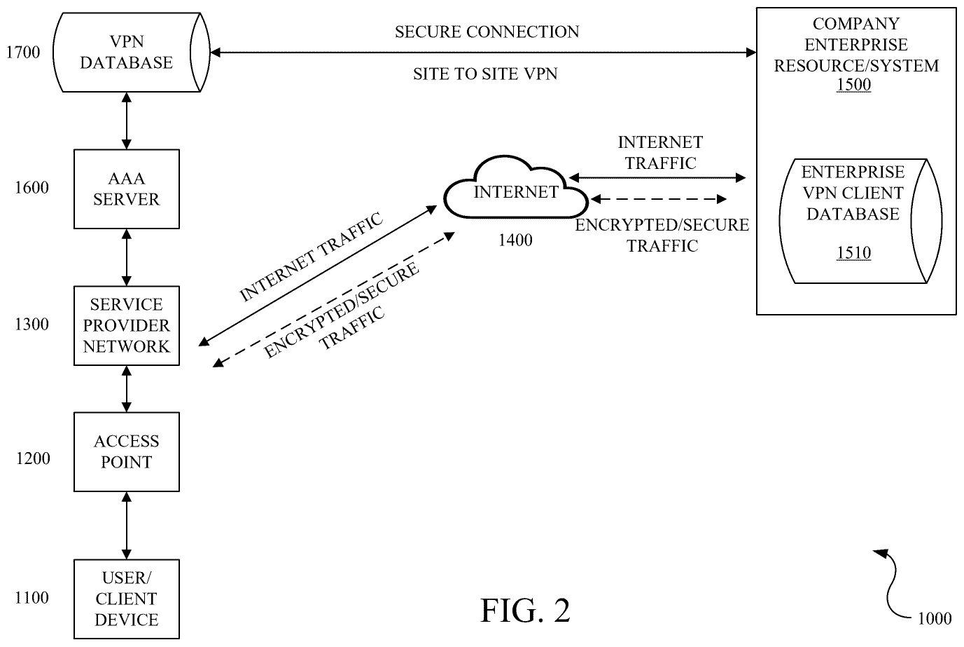

FIG. 1 is a diagram of an example of a communications architecture 1000 for use by a user, client, and/or requesting device (collectively “requesting device 1100”) in accordance with the teachings described herein and FIG. 2 is a diagram of an example of the communications network 1000 after successful authentication and virtual private network (VPN) establishment in accordance with the teachings described herein. The communications architecture 1000 can include, but is not limited to, an access point 1200, a service provider network 1300, an internet 1400, an enterprise resource or system for which a VPN connection is required (“system 1500”), a AAA server 1600, and a VPN database 1700. The number of components shown herein are illustrative and there may be more or less in the communications architecture 1000. The communications architecture 1000 and the components therein may include other elements which may be desirable or necessary to implement the devices, systems, and methods described herein. However, because such elements and steps do not facilitate a better understanding of the disclosed teachings and/or embodiments, a discussion of such elements and steps may not be provided herein.

In implementations, the requesting device 1100 can be, but is not limited to, a user and/or client device and/or an access point acting as an intermediate or relay for the user and/or client device, where the user and/or client device can be, but is not limited to, a mobile device, end user devices, Internet Protocol (IP) devices, mobile computers, laptops, handheld computers, personal media devices, smartphones, notebooks, notepads, and/or the like, all of which can be provisioned for operation with the access point 1200. In implementations, the requesting device 1100 may need access to the system 1500, which may require a VPN connection. In implementations, the requesting device 1100 may be associated with and/or be an authorized device for the system 1500. In implementations, the AAA and/or authentication server 1600 may include requirements for the requesting device 1100 to access the system 1500 such as, but not limited to, a VPN requirement. In implementations, the AAA and/or authentication server 1600 may include and/or know which system and/or enterprise is associated with the requesting device 1100 (the “associated system”). In an illustrative non-limiting example, an AAA database, such as, but not limited to, radreply, may include the VPN requirement for the system 1500 and/or the associated system. In implementations, if the requesting device 1100 is associated with the system 1500, the AAA and/or authentication server 1600 can determine whether a VPN is required and obtain VPN certificates, if necessary, as described herein.

In implementations, the access point 1200 can be an access point, an access node, and/or like device which enables radio communications access for the requesting device 1100 toward and/or from the external network including, but not limited to, the service provider network 1300, the internet 1400, and/or the system 1500. The access point 1200 may provide local wireless coverage (e.g., WiFi coverage) and/or enable a wireless local access network. The access point 1200 can be identified by access point metadata, which can include, but is not limited to, a MAC address and an IP address. In implementations, the access point 1200 may be associated with and/or be an authorized device for the system 1500.

In implementations, the service provider network 1300 can include, but is not limited to, a broadband telecommunications network, a hybrid fiber-coaxial (HFC) network, a coaxial cable network, and/or other components for carrying communications from the access point 1200 toward and/or from the external network.

In implementations, the system 1500 can be, but is not limited to, an enterprise resource, system, and/or network, which require and/or need a VPN connection for use by the requesting device 1100. The system 1500 may use VPN(s) to create secure, encrypted tunnels that allow remote users (e.g., the requesting device 1100) to access the system 1500 as if the requesting device 1100 were on the local network of the system 1500. As noted herein. while VPN connections are critical for securing sensitive data, the establishment of a VPN is typically a separate process that occurs after Wi-Fi authentication. The system 1500 also includes, but is not limited to, a VPN client database 1510 which can maintain client VPN credentials for the VPN to access the system 1500.

In implementations, the AAA and/or authentication server 1600 may provide a centralized mechanism for authenticating users and devices connecting to the system 1500. In implementations, the AAA server 1600 may be RADIUS servers. When a user (e.g., the requesting device 1100) attempts to connect to Wi-Fi (e.g., the access point 1200), the AAA server 1600 may receive authentication data and/or access point information from the access point 1200. The authentication data and/or access point information may include, but is not limited to, user credentials and access point metadata. The user credentials may be, but is not limited to, certificates and/or a username and password. The access point metadata may include, but is not limited to, a MAC address and an IP address. This authentication data and/or access point information can be used to either grant or deny access to the access point 1200 by the requesting device 1100 based on predefined policies.

In implementations, the VPN database 1700 may store VPN establishment data for multiple access points, resources, and VPNs. The VPN database may include at least an access point metadata field, a VPN and system pair field, and a connection status field. The VPN establishment data may include, but is not limited to, access point MAC address and/or IP address, VPN client data, and VPN status. The VPN establishment data may be indexed via the access point MAC address. That is, the AAA server 1600 can use the access point MAC address to query the VPN establishment data stored in the VPN database 1700. The access point MAC address can identify the physical access point. The VPN client data can indicate which VPN (e.g., a VPN type) is to be established for a given resource (e.g., a resource type). The VPN status can indicate whether a VPN connection is established or not established for a VPN. The VPN database 1700 may be updated regularly to reflect the current state of VPN connections. The VPN database 1700 can be integrated with network management systems to ensure accurate and real-time status updates. Table 1 is a non-limiting example of the VPN establishment data in the VPN database 1700:

TABLE 1

| Access Point MAC | | |
|---|---|---|
| Address | VPN Client Data | VPN Status |
| c4:41:1e:ca:9b:00 | Cisco: Chase Bank | Established |
| c4:41:1e:ca:9b:01 | Juniper: Discover Bank | Not Established |
| c4:41:1e:ca:9b:03 | Palo Alto: UnitedHealth | Not Established |

Operationally, the requesting device 1100 can initiate a local wireless connection, such as a Wi-Fi connection. The requesting device 1100 can send an authentication request (e.g., to perform an Extensible Authentication Protocol (EAP) authentication) to the access point 1200. The authentication request can include, but is not limited to, a certificate, a username and password, and/or combinations thereof (collectively “requesting device credentials”).

The access point 1200 can forward the authentication request to the AAA server 1600. In implementations, the access point 1200 can forward the requesting device credentials and the access point metadata (e.g., the MAC address and IP address of the access point 1200) to the AAA server 1600.

The AAA server 1600 can validate the requesting device credentials and check an internal RADIUS radreply table to determine the access rights of the requesting device 1100. In implementations, a RADIUS radreply or reply table is a collection of attribute-value pairs (e.g., an “access rights table or database”) which define a user's authentication and authorization. A successful validation and/or verification results in a secure connection between the access point 1200 and the requesting device 1100 as further described herein. The determination of the access rights can also include determination of VPN requirements for the resources (i.e., the system and/or enterprise) being requested by the requested device 1100. That is, the authentication request initiates both a local wireless authentication for the access point 1200 and a VPN connection, if needed.

In the instance that the verification of the requesting device credentials (also referred to herein as a local wireless authentication) is successful (which can result in a secure connection between the access point 1200 and the requesting device 1100) and a VPN connection is needed, the AAA server 1600 can query the VPN database 1700 using the MAC address of the access point 1200.

In implementations, if an entry for the access point 1200 exists in the VPN database 1700, the result of the query will indicate which VPN should be used and whether a VPN connection is already established for the identified VPN. If the required VPN is not established (as indicated by the “Not Established” state), the AAA server 1600 can trigger the establishment of a VPN connection via the access point 1200 or a network access server to the system/resource 1500 (e.g., a VPN endpoint associated with the resource). The AAA server 1600 can obtain and/or access the VPN credentials needed to establish the VPN connection from the VPN client database 1510 using a secure connection between the AAA server 1600 and the VPN client database 1510. The AAA server 1600 can provide the VPN credentials to the access point 1200. The access point 1200 can then establish a secure, encrypted VPN tunnel and/or connection to the system/resource 1500 (VPN endpoint). Upon successful VPN establishment, the access point 1200 can notify the AAA server 1600, which in turn can notify the VPN database 1700 to update the status of the VPN to “Established”. Once the VPN connection is established, the requesting device 1100 can be granted access to the local wireless network via the secure connection and to the system/resources 1500 via the VPN connection between the access point 1200 and the system/resources 1500. As shown in FIG. 2, data and/or traffic can then be sent via the secure connection and the VPN connection as encrypted traffic to and from the system/resource 1500.

As stated above, the AAA server 1600 can validate the requesting device credentials using authentication methods including, but not limited to, Extensible Authentication Protocol-Transport Layer Security (EAP-TLS), Extensible Authentication Protocol-Tunneled Transport Layer Security (EAP-TTLS), Extensible Authentication Protocol Method for Universal Mobile Telecommunications System (UMTS) Authentication and Key Agreement (EAP-AKA), Wi-Fi Protected Access 2 (WPA2), and/or Wi-Fi Protected Access 3 (WPA3). These and other authentication methods can generate encryption keys to securely transfer data from and to the requesting device 1100 and the access point 1200 (i.e., the secure connection shown in FIG. 2 between these entities). This secure connection (may also be referred to as an encrypted connection) and the VPN connection can then transfer encrypted and/or secure data between the requesting device 1100 and the system 1500 via the access point 1200.

In implementations, if an entry for the access point 1200 does not exist in the VPN database 1700, the VPN database 1700 creates a new entry in the VPN database 1700 using the access point 1200 and/or the MAC address of the access point 1200 as the index. The VPN connection is set to “Not Established.” The AAA server 1600 can trigger the establishment of a VPN connection via the access point 1200 or a network access server to the system/resource 1500 (e.g., a VPN endpoint associated with the resource). The AAA server 1600 can obtain and/or access the VPN credentials needed to establish the VPN connection from the VPN client database 1510 using a secure connection between the AAA server 1600 and the VPN client database 1510. The AAA server 1600 can provide the VPN credentials to the access point 1200. The access point 1200 can then establish a secure, encrypted VPN tunnel and/or connection to the system/resource 1500 (VPN endpoint). Upon successful VPN establishment, the access point 1200 can notify the AAA server 1600, which in turn can notify the VPN database 1700 to update the status of the VPN to “Established”. Once the VPN connection is established, the requesting device 1100 can be granted access to the local wireless network via the secure connection and to the system/resources 1500 via the VPN connection between the access point 1200 and the system/resources 1500. As shown in FIG. 2, data and/or traffic can then be sent via the secure connection and the VPN connection as encrypted traffic to and from the system/resource 1500.

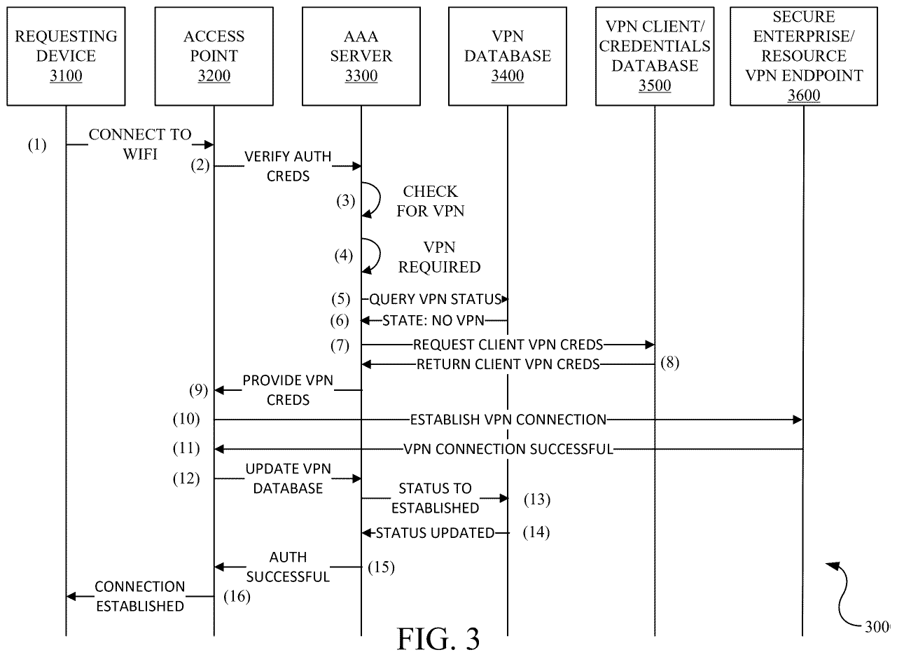

FIG. 3 is a flow diagram of an example flow 3000 for integrating virtual private network (VPN) establishment with a local wireless network authentication process in accordance with the teachings described herein. In implementations, the flow 3000 may be implemented using a requesting device 3100, an access point 3200, an AAA server 3300, a VPN database 3400, a VPN credentials database 3500, and a resource VPN endpoint 3600. In addition to the description herein, the components described herein can also include the descriptions stated herein with respect to FIGS. 1 and 2. The number of components shown herein are illustrative and there may be more or less in the flow 3000. The flow 3000 and the components therein may include other elements which may be desirable or necessary to implement the devices, systems, and methods described herein. However, because such elements and steps do not facilitate a better understanding of the disclosed teachings and/or embodiments, a discussion of such elements and steps may not be provided herein.

At (1), the requesting device 3100 can initiate a WiFi connection with the access point 3200 by sending an authentication request. At (2), the access point 3200 can authenticate the authentication credentials of the requesting device 3100 with the AAA server 3300. In this authentication request, the access point 3200 can send the authentication credentials of the requesting device 3100 and the metadata of the access point 3200, which can include at least the MAC address and IP address of the access point 3200. If the authentication fails, the requesting device 3100 is denied access to the access point 3200.

If the authentication is successful (which results in a secure connection between the requesting device 3100 and the access point 3200 when appropriate), at (3) and (4), the AAA server 3300 can use the authentication credentials of the requesting device 3100 to determine if a VPN connection is needed. If no VPN connection is needed, the requesting device 3100 is granted access to the access point 3200.

At (5), if a VPN connection is needed, the AAA server 3300 can query the VPN database 3400 using the MAC address of the access point 3200 to determine which VPN is needed and a status of a VPN connection. At (6), the VPN database 3400 can provide the VPN needed and the status of the VPN connection. If the VPN connection is already established, the requesting device 3100 is granted access to the access point 3200 to use the established VPN connection. Data traffic can be sent securely and encrypted via the secure connection and the already established VPN connection.

At (7), the AAA server 3300 can request and/or obtain the VPN credentials from the VPN credentials database 3500 if the VPN database 3400 indicates that the VPN connection is not established. In implementations, if an entry does not exist in the VPN database 3400, the VPN database 3400 creates an entry using access point metadata such as the MAC address and set the VPN connection status to not established. At (8), the VPN credentials database 3500 can provide the VPN credentials to the AAA server 3300. At (9), the AAA server 3300 can provide the VPN credentials to the access point 3200.

At (10), the access point 3200 can request establishment of a VPN connection and/or tunnel with the resource VPN endpoint 3600 using the VPN credentials. At (11), the resource VPN endpoint 3600 and the access point 3200 can successfully establish the VPN connection and/or tunnel. At (12), the access point 3200 can send confirmation of the VPN connection and/or send a request to the AAA server 3300 to update the VPN database 3400. At (13), the AAA server 3300 can send the confirmation of the VPN connection and/or send the request to the VPN database 3400. At (14), the VPN database 3400 can confirm updating of the VPN database 3400. At (15), the AAA server 3300 can notify the access point 3200 that the authentication is successful. In implementations, the notification can indicate that the VPN connection is established. At (16), the access point 3200 can notify the requesting device 3100 that the Wi-Fi connection is established, i.e., that a secure connection is established between the access point 3200 and the requesting device 3100. In implementations, the notification can indicate that the VPN connection is established between the access point 3200 and the resource VPN endpoint 3600.

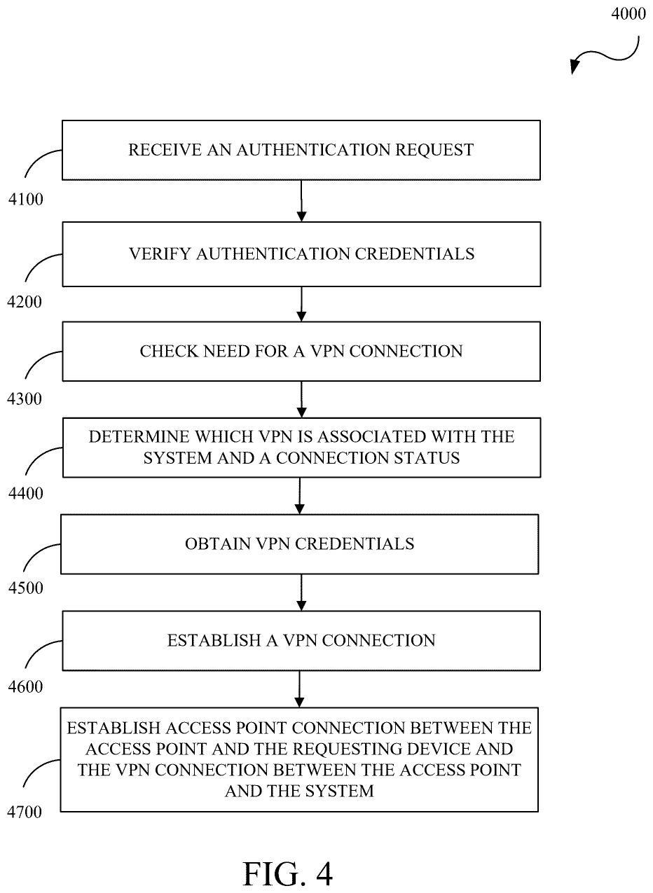

FIG. 4 is a flowchart of an example method 4000 for providing integration of a virtual private network (VPN) establishment with a local wireless network authentication process in accordance with the teachings described herein. The method 4000 includes receiving 4100 an authentication request from a requesting device to connect to an access point, verifying 4200 authentication credentials received in the authentication request, checking 4300 need for a VPN connection to connect to a system upon successful verification of the authentication credentials, determining 4400 which VPN is associated with the system and a connection status of the VPN by indexing a VPN database with access point metadata, obtaining 4500 VPN credentials from a system VPN credentials database when the connection status is unconnected, establishing 4600 a VPN connection between the access point and the system using the VPN credentials, and establishing 4700 an access point connection (secure connection) between the access point and the requesting device. The method 4000 can be implemented, for example, in or by components described with respect to FIGS. 1-3 and 7 and in conjunction with any of the flows described with respect to FIGS. 3-6, as appropriate and applicable.

The method 4000 includes receiving 4100 an authentication request from a requesting device to connect to an access point. The requesting device may be in range of an access point and wants to connect to the access point. The requesting device can send a connection or authentication request to the access point. This authentication request can include authentication credentials for the requesting device or for a user using the requesting device.

The method 4000 includes verifying 4200 authentication credentials received in the authentication request. The authentication request can trigger a two step authentication process. In the first step, a AAA server can authenticate and/or verify the authentication credentials. Successful authentication can result in a secure connection, encrypted connection, access point connection, and/or local wireless connection (collectively a “secure connection”) using encryption keys as described herein.

The method 4000 includes checking 4300 need for a VPN connection to connect to a system upon successful verification of the authentication credentials. If the authentication is successful, then in a second step, the AAA can determine the need for a VPN connection.

The method 4000 includes determining 4400 which VPN is associated with the system and a connection status of the VPN by indexing a VPN database with access point metadata. If a VPN connection is needed, the AAA server can check with a VPN database as to which VPN is needed and a VPN connection status. The access point metadata can be used to index the VPN database. If the MAC address is not in VPN database, the VPN database can establish an entry using the MAC address and set a VPN connection status to not established.

The method 4000 includes obtaining 4500 VPN credentials from a system VPN credentials database when the connection status is unconnected. If the required VPN connection is not established, the AAA server can obtain and/or request the VPN credentials from a VPN client database associated with the required VPN connection. The VPN client database is known from the VPN database based on the access point metadata.

The method 4000 includes establishing 4600 a VPN connection between the access point and the system using the VPN credentials and establishing 4700 an access point connection between the access point and the requesting device. Both a local wireless connection (the secure connection) and the VPN connection can be automatically established in one authentication process using the two step process.

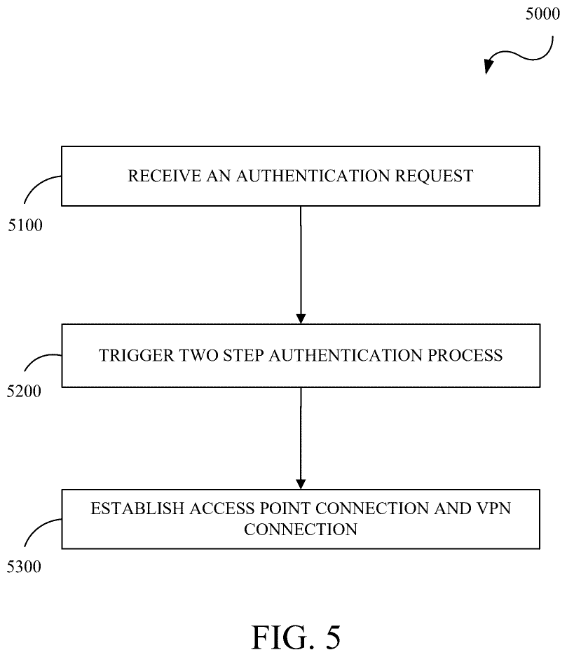

FIG. 5 is a flowchart of an example method 5000 for providing integrated virtual private network (VPN) establishment with a local wireless network authentication process in accordance with the teachings described herein. The method 5000 includes receiving 5100 an authentication request from a requesting device to connect to an access point, triggering 5200 access point authentication using requesting device credentials in the authentication request and VPN establishment using access point metadata received from the access point, and establishing 5300 an access point connection between the access point and the requesting device and a VPN connection between the access point and the system upon successful authentication. The method 5000 can be implemented, for example, in or by components described with respect to FIGS. 1-3 and 7 and in conjunction with any of the flows described with respect to FIGS. 3-4 and 6, as appropriate and applicable.

The method 5000 includes receiving 5100 an authentication request from a requesting device to connect to an access point. The requesting device may be in range of an access point and wants to connect to the access point. The requesting device can send a connection or authentication request to the access point. This authentication request can include authentication credentials for the requesting device or for a user using the requesting device.

The method 5000 includes triggering 5200 access point authentication using requesting device credentials in the authentication request and VPN establishment using access point metadata received from the access point. The authentication request can trigger a two step authentication process. In the first step, a AAA server can authenticate and/or verify the requesting device credentials. If the authentication is successful, then in a second step, the AAA can determine the need for a VPN connection. If the VPN connection is needed, the AAA server can check with a VPN database as to which VPN is needed and a VPN connection status. The access point metadata can be used to index the VPN database. If the MAC address is not in VPN database, the VPN database can establish an entry using the MAC address and set a VPN connection status to not established. If the required VPN connection is not established, the AAA server can obtain and/or request the VPN credentials from a VPN client database associated with the required VPN connection. The VPN client database is known from the VPN database based on the access point metadata.

The method 5000 includes establishing 5300 an access point connection between the access point and the requesting device and a VPN connection between the access point and the system upon successful authentication. Both the local wireless connection and the VPN connection can be established in one authentication process using the two step process. That is, the one authentication request can automatically trigger two authentication processes, one for the access point connection and one for the VPN connection, when needed.

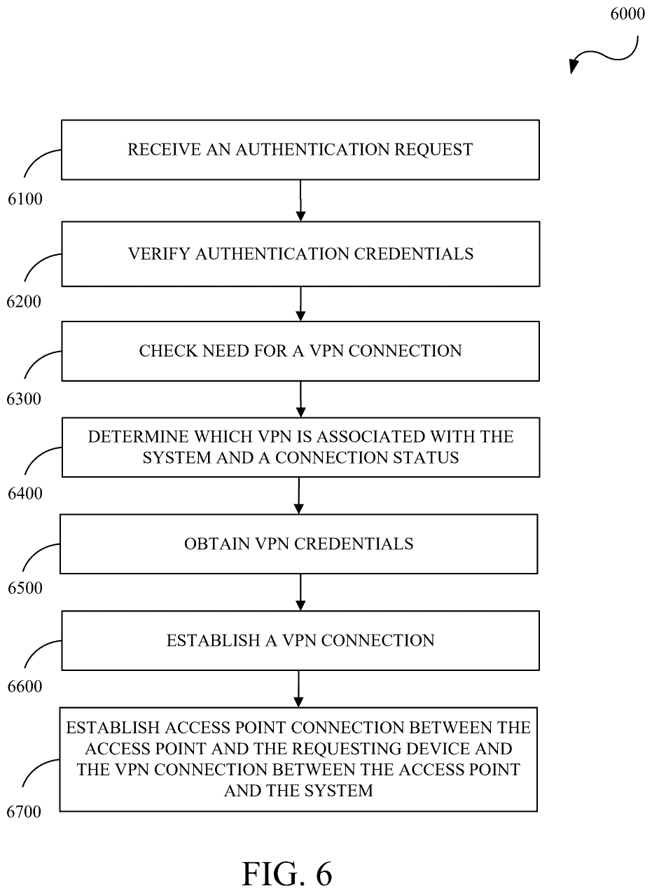

FIG. 6 is a flowchart of an example method 6000 for providing integrated virtual private network (VPN) establishment with a local wireless network authentication process in accordance with the teachings described herein. The method 6000 includes receiving 6100 by an access point from a requesting device an authentication request to connect to an access point, verifying 6200 by an authentication server authentication credentials received in the authentication request, checking 6300 by the authentication server a VPN connection requirement for the authentication request upon successful verification of the authentication credentials, using 6400 by the authentication server access point metadata and a VPN database to determine which VPN to use and a connection status of the VPN when the VPN connection requirement is positive, obtaining 6500 by the authentication server, VPN credentials for the VPN when the connection status of the VPN is unconnected, and establishing 6600 an access point connection between the access point and the requesting device and a VPN connection between the access point and a system associated with the VPN credentials. The method 6000 can be implemented, for example, in or by components described with respect to FIGS. 1-3 and 7 and in conjunction with any of the flows described with respect to FIGS. 3-5, as appropriate and applicable.

The method 6000 includes receiving 6100 by an access point from a requesting device an authentication request to connect to an access point. The requesting device may be in range of an access point and wants to connect to the access point. The requesting device can send a connection or authentication request to the access point. This authentication request can include authentication credentials for the requesting device or for a user using the requesting device.

The method 6000 includes verifying 6200 by an authentication server authentication credentials received in the authentication request. The authentication request can trigger a two step authentication process. In the first step, a AAA server can authenticate and/or verify the authentication credentials.

The method 6000 includes checking 6300 by the authentication server a VPN connection requirement for the authentication request upon successful verification of the authentication credentials. If the authentication is successful, then in a second step, the AAA can determine the need for a VPN connection.

The method 6000 includes using 6400 by the authentication server access point metadata and a VPN database to determine which VPN to use and a connection status of the VPN when the VPN connection requirement is positive. If a VPN connection is needed, the AAA server can check with a VPN database as to which VPN is needed and a VPN connection status. The access point metadata can be used to index the VPN database.

The method 6000 includes obtaining 6500 by the authentication server, VPN credentials for the VPN when the connection status of the VPN is unconnected. If the access point metadata is not in VPN database, the VPN database can establish an entry using the access point metadata and set a VPN connection status to not established. If the required VPN connection is not established, the AAA server can obtain and/or request the VPN credentials from a VPN client database associated with the required VPN connection. The VPN client database is known from the VPN database based on the access point metadata.

The method 6000 includes establishing 6600 an access point connection between the access point and the requesting device and a VPN connection between the access point and a system associated with the VPN credentials. Both the local wireless connection and the VPN connection can be established in one authentication process using the two step process. That is, the one authentication request can automatically trigger two authentication processes, one for the access point connection and for the VPN connection, when needed.

Described herein is a non-limiting scenario for using the system and method for enabling integration of a virtual private network (VPN) establishment with a local wireless network authentication process in accordance with the teachings described herein. In this scenario, the VPN database may have data populated as shown in Table 2:

TABLE 2

| Access Point MAC | | |
|---|---|---|
| Address | VPN Client Data | VPN Status |
| c4:41:1e:ca:9b:00 | Cisco: Chase Bank | Established |
| c4:41:1e:ca:9b:01 | Juniper: Discover Bank | Not Established |

A user (via a requesting device) connects through an access point, which has a MAC address c4:41:1e:ca:9b:01. During the Wi-Fi authentication process (which if successful results in a secure connection between the requesting device and the access point), a AAA server checks the VPN database and determines that the user is required to use the Juniper-Discover-Bank VPN and further notes that VPN is currently “Not Established.” The AAA server then initiates the VPN connection from the access point to the Discover-Bank VPN endpoint, after which the user is allowed to securely access enterprise resources via the secure connection and the VPN connection. The VPN database can be updated as shown in Table 3:

TABLE 3

| Access Point MAC | | |
|---|---|---|
| Address | VPN Client Data | VPN Status |
| c4:41:1e:ca:9b:00 | Cisco: Chase Bank | Established |
| c4:41:1e:ca:9b:01 | Juniper: Discover Bank | Established |

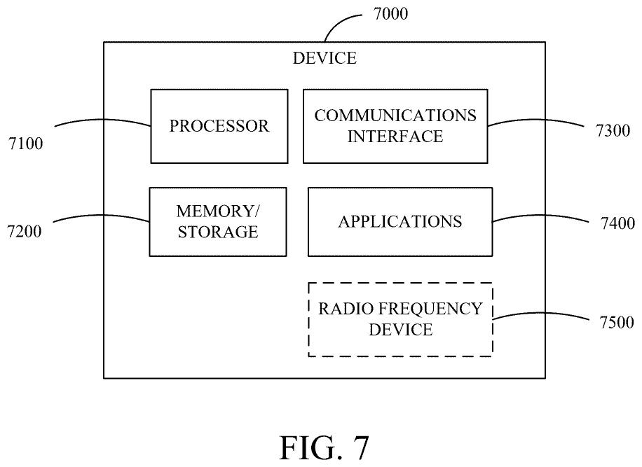

FIG. 7 is a block diagram of an example of a device 7000 in accordance with the teachings described herein. The device 7000 may include, but is not limited to, a processor 7100, a memory/storage 7200, a communication interface 7300, applications 7400, and, if needed, a radio frequency device 7500. The device 7000 may include or implement, for example, the systems and components described with respect to FIGS. 1-3 and the implement the methods of FIGS. 3-6. The applicable or appropriate flows, techniques, or methods described herein may be stored in the memory/storage 7200 and executed by the processor 7100 in cooperation with the memory/storage 7200, the communications interface 7300, the applications 7400, and the radio frequency device 7500 (when applicable), as appropriate. The device 7000 may include other elements which may be desirable or necessary to implement the devices, systems, and methods described herein. However, because such elements and steps do not facilitate a better understanding of the disclosed embodiments, a discussion of such elements and steps may not be provided herein.

Described is a method for providing integrated virtual private network (VPN) establishment with wireless network authentication. In implementations, the method includes receiving, by an access point from a requesting device, an authentication request to connect to an access point, verifying, by an authentication server, authentication credentials received in the authentication request and a requirement of a VPN connection, using, by the authentication server, access point metadata and a VPN database to determine which VPN to use and a connection status of the VPN upon successful verification of the authentication credentials and when the requirement of the VPN connection is positive, obtaining, by the authentication server, VPN credentials for the VPN when the connection status of the VPN is unconnected, and establishing an access point connection between the access point and the requesting device and a VPN connection between the access point and a system associated with the VPN credentials.

In implementations, the verifying further includes receiving, by the authentication server from the access point, the authentication credentials and the access point metadata. In implementations, the method further includes checking, by the authentication server, the VPN connection requirement for the authentication request. In implementations, the using further includes indexing, by the authentication server into the VPN database, with the access point metadata. In implementations, the access point metadata is a Media Access Control (MAC) address. In implementations, the access point metadata is an Internet Protocol (IP) address. In implementations, entries in the VPN database include at least an access point metadata field, a VPN and system pair field, and a connection status field. In implementations, the method further includes updating, by the authentication server, the VPN database upon successful establishment of the VPN connection for the VPN.

Described is a method for providing integrated virtual private network (VPN) establishment with wireless network authentication. In implementations, the method includes receiving, by an access point from a requesting device, an authentication request to connect to the access point, triggering, at an authentication server, access point authentication using requesting device credentials including in the authentication request and VPN establishment using access point metadata received from the access point, and establishing an access point connection between the access point and the requesting device and a VPN connection between the access point and a system upon successful authentication.

In implementations, the method further includes verifying, by the authentication server, the requesting device credentials. In implementations, the triggering further includes using, by the authentication server, the access point metadata to index into a VPN database to determine which VPN to use and a connection status of the VPN upon successful verification of the requesting device credentials and when a VPN connection requirement is positive based on the requesting device credentials. In implementations, the method further includes obtaining, by the authentication server, VPN credentials for the VPN when the connection status of the VPN is unconnected. In implementations, entries in the VPN database include at least an access point metadata field, a VPN and system pair field, and a connection status field. In implementations, the triggering further includes checking, by the authentication server, the VPN connection requirement for the authentication request. In implementations, the method further includes updating, by the authentication server, the VPN database upon successful establishment of the VPN connection for the VPN.

Described is a system for providing integrated virtual private network (VPN) establishment with wireless network authentication. In implementations, the system includes a virtual private network (VPN) database, wherein an entry in the VPN database includes at least an access point metadata field, a VPN and system pair field, and a connection status field, and an authentication server. In implementations, the authentication server is configured to receive authentication credentials for a requesting device that wants to connect to an access device and access point metadata for the access device, verify the authentication credentials, check a VPN connection requirement based on verified authentication credentials, determine from the VPN database which VPN to use and a connection status based on a positive VPN connection requirement, wherein the VPN database is indexed using the access point metadata, obtain VPN credentials for the VPN when the connection status of the VPN is unconnected, and send verification successful and the VPN credentials to the access device to establish an access point connection between the access point and the requesting device and a VPN connection between the access point and a system associated with the VPN credentials.

In implementations, the authentication server is further configured to update the VPN database upon successful establishment of the VPN connection for the VPN. In implementations, the access point metadata is at least one of a Media Access Control (MAC) address and an Internet Protocol (IP) address. In implementations, the VPN database is configured to create an entry in the VPN database for the access device upon unsuccessfully matching the access point metadata in the VPN database. In implementations, the VPN database is configured to set a connection status of a VPN to unconnected for the entry.

Although some teachings and/or embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to teachings and/or embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various teachings and/or embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain teachings and/or embodiments, it is to be understood that the disclosure is not to be limited to the disclosed teachings and/or embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for providing integrated virtual private network (VPN) establishment with wireless network authentication, the method comprising:
receiving, by an access point from a requesting device, an authentication request to connect to the access point;
verifying, by an authentication server, authentication credentials received in the authentication request and a requirement of a VPN connection;
using, by the authentication server, access point metadata and a VPN database to determine which VPN to use and a connection status of the VPN upon successful verification of the authentication credentials and when the requirement of the VPN connection is positive;
obtaining, by the authentication server, VPN credentials for the VPN when the connection status of the VPN is unconnected; and
establishing an access point connection between the access point and the requesting device and a VPN connection between the access point and a system associated with the VPN credentials.

2. The method of claim 1, wherein the verifying further comprising:
receiving, by the authentication server from the access point, the authentication credentials and the access point metadata.

3. The method of claim 1, further comprising:
checking, by the authentication server, the VPN connection requirement for the authentication request.

4. The method of claim 1, wherein the using further comprising:
indexing, by the authentication server into the VPN database, with the access point metadata.

5. The method of claim 1, wherein the access point metadata is a Media Access Control (MAC) address.

6. The method of claim 1, wherein the access point metadata is an Internet Protocol (IP) address.

7. The method of claim 1, wherein entries in the VPN database include at least an access point metadata field, a VPN and system pair field, and a connection status field.

8. The method of claim 1, further comprising:
updating, by the authentication server, the VPN database upon successful establishment of the VPN connection for the VPN.

9. A method for providing integrated virtual private network (VPN) establishment with local wireless network authentication, the method comprising:
receiving, by an access point from a requesting device, an authentication request to connect to the access point;
triggering, at an authentication server, access point authentication using requesting device credentials included in the authentication request and VPN establishment using access point metadata received from the access point; and
establishing an access point connection between the access point and the requesting device and a VPN connection between the access point and a system upon successful authentication.

10. The method of claim 9, further comprising:
verifying, by the authentication server, the requesting device credentials.

11. The method of claim 9, wherein the triggering further comprising:
using, by the authentication server, the access point metadata to index into a VPN database to determine which VPN to use and a connection status of the VPN upon successful verification of the requesting device credentials and when a VPN connection requirement is positive based on the requesting device credentials.

12. The method of claim 11, further comprising:
obtaining, by the authentication server, VPN credentials for the VPN when the connection status of the VPN is unconnected.

13. The method of claim 11, wherein entries in the VPN database include at least an access point metadata field, a VPN and system pair field, and a connection status field.

14. The method of claim 11, further comprising:
updating, by the authentication server, the VPN database upon successful establishment of the VPN connection for the VPN.

15. The method of claim 9, wherein the triggering further comprising:
checking, by the authentication server, a VPN connection requirement for the authentication request.

16. A system, comprising:
a virtual private network (VPN) database, wherein an entry in the VPN database includes at least an access point metadata field, a VPN and system pair field, and a connection status field; and
an authentication server, wherein the authentication server is configured to:
receive authentication credentials for a requesting device that wants to connect to an access device and access point metadata for the access device;
verify the authentication credentials;
check a VPN connection requirement based on verified authentication credentials;
determine from the VPN database which VPN to use and a connection status based on a positive VPN connection requirement, wherein the VPN database is indexed using the access point metadata;
obtain VPN credentials for the VPN when the connection status of the VPN is unconnected; and
send verification successful and the VPN credentials to the access device to establish an access point connection between the access device and the requesting device and a VPN connection between the access device and a system associated with the VPN credentials.

17. The system of claim 16, wherein the authentication server is further configured to:
update the VPN database upon successful establishment of the VPN connection for the VPN.

18. The system of claim 16, wherein the access point metadata is at least one of a Media Access Control (MAC) address and an Internet Protocol (IP) address.

19. The system of claim 16, wherein the VPN database is configured to:
create a new entry in the VPN database for the access device upon unsuccessfully matching the access point metadata in the VPN database.

20. The system of claim 19, wherein the VPN database is configured to:
set a connection status of a VPN to unconnected for the new entry.
